(19) United States
(12) Patent Application Publication
(10) Pub. No.: US 2022/0290758 A1
(43) Pub. Date: Sep. 15, 2022

(54) GASKET

(71) Applicant: NOK CORPORATION, Tokyo (JP)

(72) Inventor: Tasuku ONO, Aso (JP)

(21) Appl. No.: 17/637,503

(22) PCT Filed: Jun. 22, 2020
(86) PCT No.: PCT/JP2020/024351

§ 371 Date: Feb. 23, 2022

(30) Foreign Application Priority Data
Sep. 4, 2019 (JP) 2019-161382

(51) Int. Cl. F16J 15/10

(52) U.S. Cl. CPC F16J 15/104; F16J 15/102

(57) ABSTRACT

A gasket is formed from an elastomer material. The gasket includes a compressed portion to be compressed between first and second members, an inserted portion to be inserted into a groove of the first member, and a neck portion connecting the compressed and inserted portions. The compressed portion includes a hollow structure having a cavity. The compressed portion includes a substantially rectangular contour having a first outer surface to contact the first member and a second outer surface opposite the first outer surface and to contact the second member. The first outer surface has a first recess having a first width, the first recess having a center to which the neck portion is coupled. The second outer surface has a second recess having a second width. The first recess overlaps the second recess, and the first width is different from the second width.

### CROSS REFERENCE TO RELATED APPLICATIONS

This application is a U.S. National Phase Application under 35 U.S.C. 371 of International Application No. PCT/JP2020/024351, filed on Jun. 22, 2020, which claims priority to Japanese Patent Application No. 2019-161382, filed on Sep. 4, 2019. The entire disclosures of the above applications are expressly incorporated by reference herein.

### BACKGROUND

### Technical Field

The present invention relates to gaskets.

### Related Art

Japanese Utility Model Publication No. 5-81565 discloses a gasket that has a hollow structure and maintains a reaction force over a long period of time.

It is preferable that a gasket that is compressed between members to seal a gap between the members maintain sealing ability over a long period of time even if the flatness of the members is low.

In addition, depending on an environment in which the gasket is used, it may be preferable for a gasket to have a low reaction force exerted on the members. For example, when the strength of the members for which the gasket is deployed is low, it is preferable that the gasket exerts as little reaction force as possible on the members.

Furthermore, it is preferable that a gasket to be compressed have high repeatability of deformation. For example, if a gasket is inclined relative to an expected shape, it is difficult to achieve or maintain sealing ability between members.

### SUMMARY

Accordingly, the present invention provides a gasket that is capable of maintaining sealing ability over a long period of time even if flatness of the surrounding members is low, and that is compressed with low reaction force exerted on the surrounding members and high repeatability of deformation.

According to an aspect of the present invention, there is provided a gasket including a compressed portion formed from an elastomer material and adapted to be compressed between a first member and a second member, the compressed portion having a width; an inserted portion formed from the elastomer material and adapted to be inserted into a groove formed in the first member, the inserted portion having a maximum width; and a neck portion formed from the elastomer material having a width that is less than the width of the compressed portion and the maximum width of the inserted portion, the neck portion being integrally coupled with the compressed portion and the inserted portion and connecting the compressed portion and the inserted portion. The compressed portion includes a hollow structure having a cavity, and includes a substantially rectangular contour including a first outer surface adapted to be brought into contact with the first member and a second outer surface that is opposite to the first outer surface and adapted to be brought into contact with the second member. The first outer surface includes a first recess having a first width, the first recess having a center to which the neck portion is coupled. The second outer surface includes a second recess having a second width. The first recess overlaps the second recess, and the first width is different from the second width.

According to this aspect, since the compressed portion has a hollow structure, even if the flatness of the first member and the second member is low, the compressed portion can maintain the sealing ability thereof for a long period of time, and the reaction force exerted on the first member and the second member is small. The inserted portion is fixed to the first member by being inserted into the groove of the first member, and supports the compressed portion. Furthermore, in this aspect, the first and second recesses are formed on the mutually opposite first and second outer surfaces of the compressed portion, respectively, and the widths of the recesses are different. Both ends of the first recess and both ends of the second recess are points that initially receive compressive load in the deformation of the compressed gasket. If the first width of the first recess and the second width of the second recess are equal, the compressed portion may tilt relative to the inserted portion as the compressed portion is compressed, and moreover, the deformation behavior of the uncompressed portion is not reproducible. However, in this aspect, the first recess overlaps the second recess, and the first and second widths are different, so that the compressed portion does not tilt relative to the inserted portion and is compressed with high repeatability of shape, e.g., while maintaining linear symmetry. Accordingly, the gasket according to this aspect has a high degree of certainty of achieving a desired sealing ability.

### BRIEF DESCRIPTION OF THE DRAWINGS

FIG. 1 is a schematic view of an electric automotive vehicle in which a gasket according to an embodiment of the present invention is used;

FIG. 2 is a plan view of a battery case in the electric automotive vehicle of FIG. 1;

FIG. 3 is a cross-sectional view taken along line III-III in FIG. 2;

FIG. 4 is a cross-sectional view of the gasket according to a first embodiment of the present invention;

FIG. 5 is a cross-sectional view of the gasket according to the first embodiment compressed between a lid and a flange of the battery case;

FIG. 6 is a graph showing distribution of the contact pressure exerted by the gasket on the battery case in the state shown in FIG. 5;

FIG. 7 is a cross-sectional view of the gasket of the first embodiment compressed more strongly than the state in FIG. 5;

FIG. 8 is a graph showing distribution of the contact pressure exerted by the gasket on the battery case in the state shown in FIG. 7;

FIG. 9 is a cross-sectional view of the gasket of the first embodiment compressed more strongly than the state in FIG. 7;

FIG. 10 is a graph showing distribution of the contact pressure exerted by the gasket on the battery case in the state shown in FIG. 9;

FIG. 11 is a cross-sectional view of a gasket according to a comparative example;

FIG. 12 is a cross-sectional view of the gasket according to the comparative example compressed between the lid and flange of the battery case;

FIG. 13 is a cross-sectional view of a gasket according to the comparative example that is compressed more strongly than the state in FIG. 12;

FIG. 14 is a cross-sectional view of a gasket according to another comparative example;

FIG. 15 is a cross-sectional view of the gasket according to the comparative example in FIG. 14 compressed between the lid and flange of the battery case; and

FIG. 16 is a cross-sectional view of a gasket according to a second embodiment of the present invention.

### DETAILED DESCRIPTION

Hereinafter, with reference to the accompanying drawings, various embodiments according to the present invention will be described. It is of note that the drawings are not necessarily to scale, and certain features may be exaggerated or omitted.

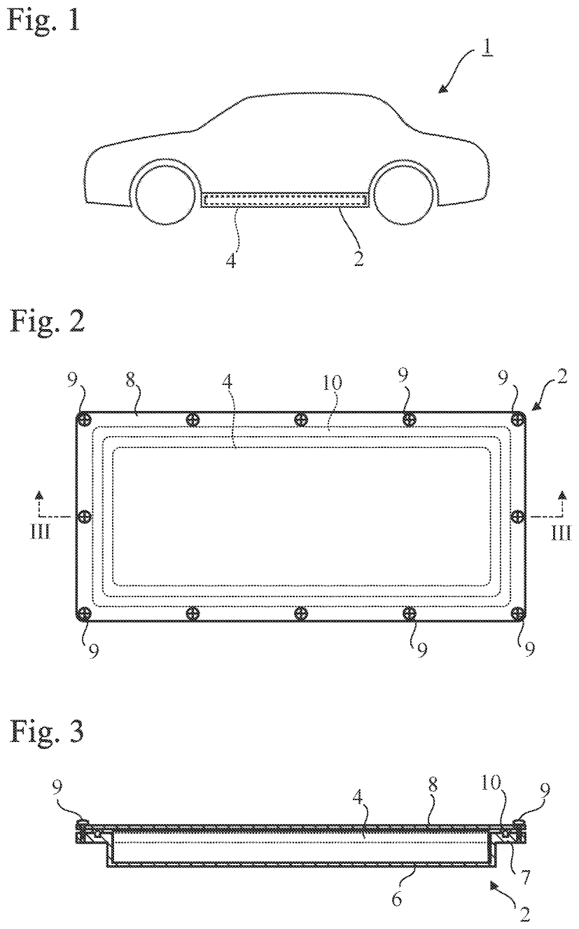

FIG. 1 is a schematic view of an electric automotive vehicle 1 in which a gasket according to an embodiment of the present invention is used. A thin battery case 2 having a large area is located at a lower portion of the electric automotive vehicle 1. The battery case 2 holds a battery 4 in the inside thereof.

As shown in FIGS. 2 and 3, the battery case 2 includes a container 6 in which the battery case 2 is placed, and a lid 8 that is a flat plate covering the container 6. The container 6 and the lid 8 are made from a metal, such as an aluminum alloy. A flange 7 is formed on the peripheral portion of the container 6, and the lid 8 is fixed to the flange 7 by a plurality of screws 9.

Between the flange 7 (first member) and the lid 8 (second member), a gasket 10 formed from an elastomer material having an endless loop shape is disposed. As shown in FIG. 2, the gasket 10 has a contour similar to that of the flange 7, and is compressed between the flange 7 and the lid 8 to separate the inner space of the loop shape from the outer space (i.e., the inner space of the container 6 from the outer space).

### First Embodiment

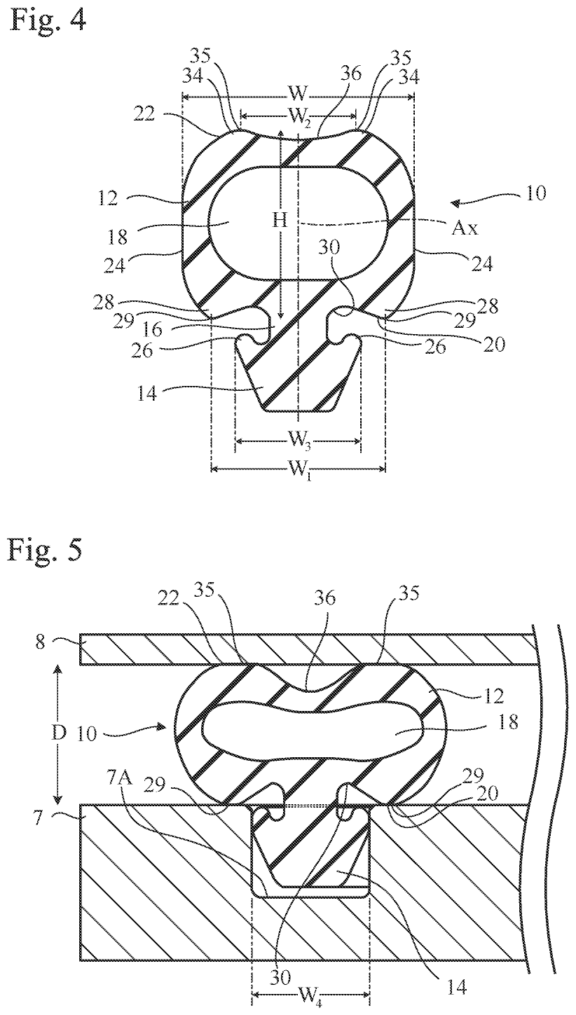

FIG. 4 is a cross-sectional view of the gasket 10 according to a first embodiment of the present invention. FIG. 4 shows the gasket 10 in an uncompressed state, i.e., in an unused state in which it is not deployed between the flange 7 and the lid 8.

As shown in FIG. 4, the gasket 10 has a linearly symmetrical cross-section about the central axis Ax. The gasket 10 has a compressed portion 12, an inserted portion 14, and a neck portion 16. The gasket 10 has a compressed portion 12, an inserted portion 14, and a neck portion 16.

The compressed portion 12 is adapted to be compressed between the flange 7 and the lid 8, as shown in FIGS. 5, 7, and 9. The compressed portion 12 has a hollow structure with a cavity 18 in the center thereof. The illustrated cavity 18 is elliptical with semi-circular ends, but it may be oval or substantially rectangular.

The compressed portion 12 has a substantially rectangular contour. Specifically, the compressed portion 12 has a lower surface 20 (first outer surface) that is adapted to be brought into contact with the flange 7, and an upper surface 22 (second outer surface) that is opposite to the lower surface 20 and is adapted to be in contact with the lid 8, and two side surfaces 24. There is a bottom wall of the compressed portion 12 between the lower surface 20 and the cavity 18, and there is a top wall of the compressed portion 12 between the upper surface 22 and the cavity 18. Between each side surface 24 and the cavity 18, there is a side wall of the compressed portion 12.

In this specification, expressions related to directions, for example, upper surface and lower surface, are based on the orientation of the gasket 10 shown in the drawings for ease of understanding, but are not intended to limit the orientation of the gasket in the drawings.

As shown in FIG. 4, in the uncompressed state, the height H of the compressed portion 12, i.e. the distance between the lower surface 20 and the upper surface 22, is less than the width W of the compressed portion 12, i.e., the distance between the side surfaces 24. The height of the cavity 18 is also less than the width of the cavity 18.

The inserted portion 14 is adapted to be inserted into a groove 7A having a rectangular cross-section formed in the flange 7, as shown in FIGS. 5, 7, and 9. The inserted portion 14 has a tapered shape having a width that decreases as the distance from the compressed portion 12 increases. Accordingly, the inserted portion 14 can be easily inserted into the groove 7A.

The inserted portion 14 has a maximum width W₃ that is less than the width W of the compressed portion 12 in the uncompressed state. In the uncompressed state, the maximum width W₃ of the inserted portion 14 is greater than the width W₄ of the groove 7A. Accordingly, once the inserted portion 14 is inserted into the groove 7A, the inserted portion 14 adheres to both walls of the groove 7A, so that the gasket 10 is firmly fixed to the flange 7.

The neck portion 16 is integrally coupled with the compressed portion 12 and the inserted portion 14, and connects the compressed portion 12 and the inserted portion 14. The neck portion 16 has a width that is less than the width W of the compressed portion 12 and the maximum width W₃ of the insertion part 14. In the uncompressed state, the two side surfaces of the neck portion 16 are parallel to each other.

The inserted portion 14 has two projections 26. The projections 26 are located on both sides of the neck portion 16 and extend toward the compressed portion 12 in a manner similar to the arms of an anchor. The projections 26 increase the maximum width W₃ of the inserted portion 14, thereby ensuring a large interference of the inserted portion 14 to the walls of the groove 7A. Accordingly, the inserted portion 14 is firmly attached to the flange 7.

At both ends of the lower surface 20 of the compressed portion 12, ridges 28 protruding toward the inserted portion 14 are formed. Between the apexes 29 of the two ridges 28, there is provided a recess 30 (first recess). The neck portion 16 is coupled to the center of the recess 30. The recess 30 has a width W₁ (the distance between the apexes 29 of the two ridges 28).

At both ends of the upper surface 22 of the compressed portion 12, ridges 34 protruding away from the inserted portion 14 are formed. Between the apexes 35 of the two ridges 34, there is provided a recess 36 (second recess). The recess 36 has a width W₂ (the distance between the apexes 35 of the two ridges 34).

In the direction along the central axis Ax, the recess 30 on the lower surface 20 overlaps the recess 36 on the upper surface 22. In the uncompressed state, the width W₁ (first width) of the recess 30 and the width W₂ (second width) of the recess 36 are different. More specifically, in this embodiment, the width W₁ is greater than the width W₂ in the uncompressed state.

In the uncompressed state, the width of the cavity 18 is substantially the same as the width W₁ of the recess 30 and is greater than the width W₂ of the recess 36.

As described above, the gasket 10 has an endless loop shape. Accordingly, each of the compressed portion 12, the inserted portion 14, and the neck portion 16 is formed in an endless loop, and can separate the inner space of the loop from the outer space.

The loop-shaped gasket 10 can be manufactured by joining the ends of a long gasket material having the cross-section shown in FIG. 4.

As shown in FIG. 4, the compressed portion 12, the inserted portion 14, and the neck portion 16 have cross-sections that are linearly symmetrical about the central axis Ax. The long gasket material having such cross-sections can be easily manufactured using a mold having a linearly symmetrical cavity. A specific method of manufacturing it is preferably extrusion molding.

The raw material of the gasket 10 is, for example, EPDM (ethylene propylene diene rubber), but it may be other rubber material such as fluororubber, silicone rubber, etc.

The raw material of the gasket 10 is processed into a long gasket material, and then, is cross-linked, for example, by heating with ultra-high frequency (UHF) or steam. Preferably, the hardness of the gasket 10, measured with a type A durometer according to HS K 6253, is from 50 to 80, and more preferably from 50 to 70.

The long gasket material is processed into a loop shape, for example, by joining its ends with glue or by joining its ends by pressurizing and heating using a mold. The joined portion does not need to have the cavity 18.

Although not shown in the drawings, at least one air vent hole is preferably formed in the compressed portion 12. The air vent hole permits air to flow into and out of the cavity 18.

FIG. 5 is a cross-sectional view of the gasket 10 compressed with a small force between the lid 8 and the flange 7 of the battery case 2. FIG. 7 is a cross-sectional view of the gasket 10 compressed with a stronger force, whereby the distance D between the lid 8 and the flange 7 is narrowed in comparison with the state shown in FIG. 5. FIG. 9 is a cross-sectional view of the gasket 10 compressed with a stronger force than in FIG. 7, whereby the distance D between the lid 8 and the flange 7 is narrowed in comparison with the state shown in FIG. 7.

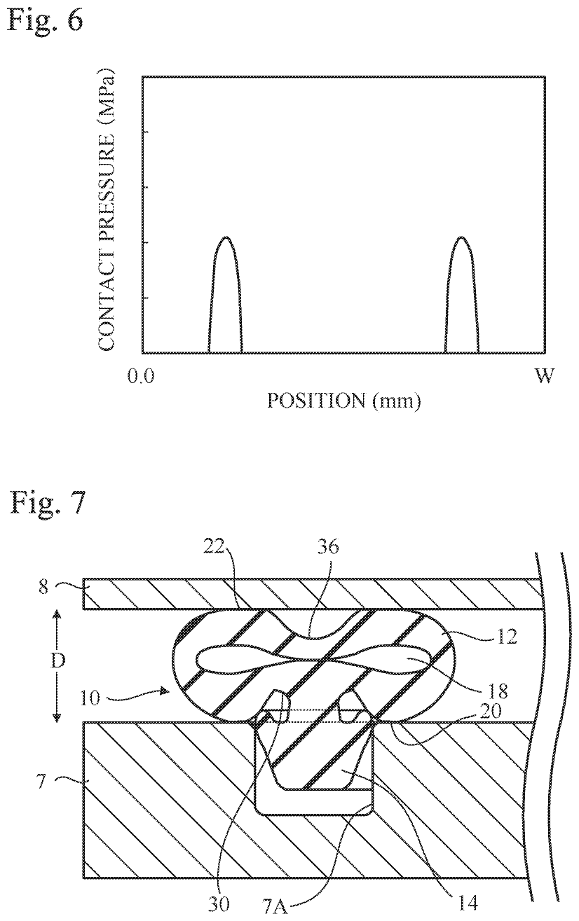

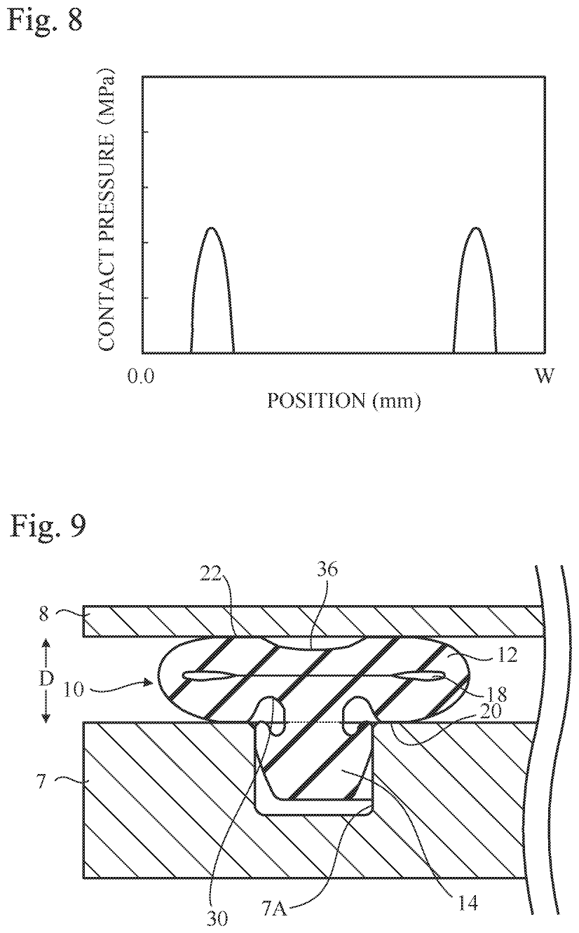

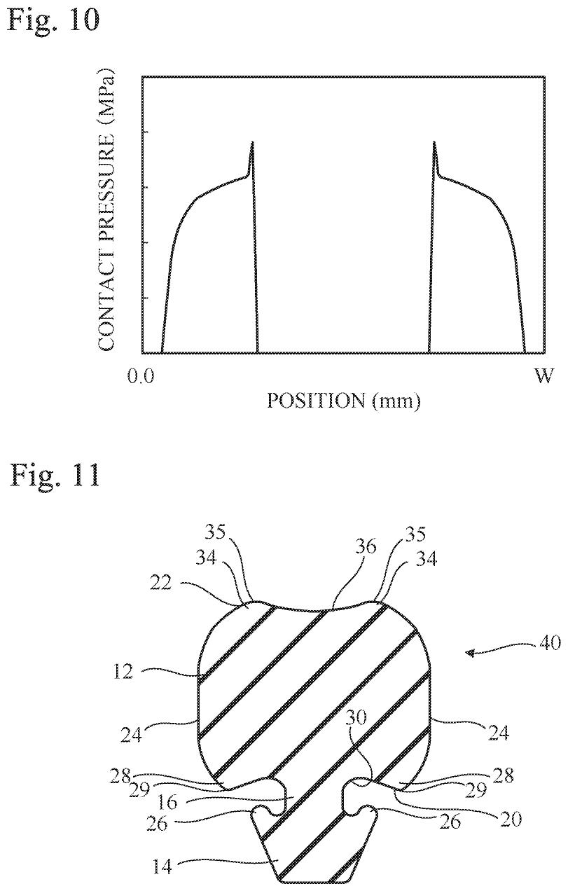

FIG. 6 shows distribution of the contact pressure exerted by the lower surface 20 of the gasket 10 on the flange 7 in the state of FIG. 5. FIG. 8 shows distribution of the contact pressure exerted by the lower surface 20 of the gasket 10 on the flange 7 in the state of FIG. 7. FIG. 10 shows distribution of the contact pressure exerted by the lower surface 20 of the gasket 10 on the flange 7 in the state shown in FIG. 9. These graphs were obtained from results of simulations using a finite element method. The horizontal axis in FIGS. 6, 8, and 10 corresponds to the width direction of the gasket 10, and thus, FIGS. 6, 8, and 10 show the distribution of the contact pressure in the width direction of the gasket 10.

As the distance D between the lid 8 and the flange 7 decreases, the cavity 18 shrinks and the side walls of the compressed portion 12 widen outward. In addition, as the distance D between the lid 8 and the flange 7 decreases, the contact area between the lower surface 20 of the gasket 10 and the flange 7 increases, and the contact area between the upper surface 22 and the lid 8 also increases. Accordingly, the distribution of the contact pressure in FIGS. 6, 8, and 10 also increases.

In the gasket 10, the compressed portion 12 has a hollow structure with the cavity 18, so that even if the flatness of the surface of the flange 7 and the surface of the lid 8 is low, the compressed portion 12 can maintain the sealing ability thereof for a long period of time, and the reaction force exerted on the flange 7 and the lid 8 is low.

FIG. 11 shows a cross-section of a gasket 40 according to a comparative example in the uncompressed state. The gasket 40 according to the comparative example does not have a cavity 18, but other features are the same as those in the gasket 10 according to the embodiment.

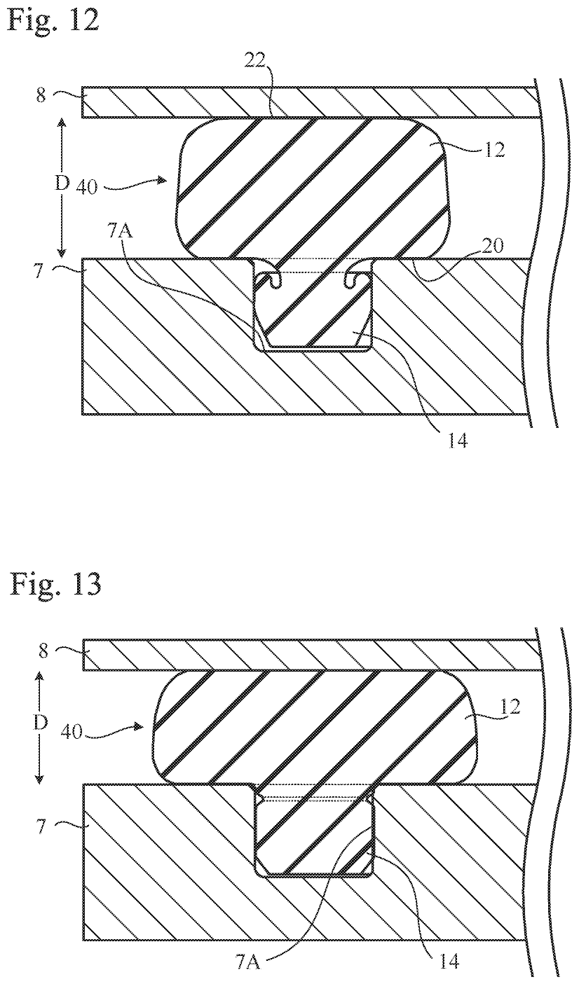

FIG. 12 is a cross-sectional view of the gasket 40 compressed with a small force between lid 8 and flange 7 of battery case 2, in which the distance D between the lid 8 and the flange 7 is the same as that in FIG. 5. FIG. 13 is a cross-sectional view of the gasket 40 compressed with a stronger force, in which the distance D between the lid 8 and the flange 7 is narrower than that in FIG. 12 and is the same as that in FIG. 7.

As can be seen from comparison of FIG. 5 and FIG. 12 and from comparison of FIG. 6 and FIG. 13, the compressed portion 12 having the cavity 18 of the gasket 10 according to the embodiment is much easier to deform than the compressed portion 12 without the cavity 18 of the gasket 40 according to the comparative example. According to the results of simulation using the finite element method, the reaction force exerted on the lid 8 by the gasket 10 according to the embodiment in the state of FIG. 5 is one-seventh of the reaction force exerted on the lid 8 by the gasket 40 according to the comparative example in the state of FIG. 12. In addition, the reaction force exerted on the lid 8 by the gasket 10 according to the embodiment in the state shown in FIG. 6 is 1/12.3 of the reaction force exerted on the lid 8 by the gasket 40 according to the comparative example in the state of FIG. 13 and is 1/4.2 of the reaction force exerted on the lid 8 by the gasket 40 according to the comparative example in the state of FIG. 12. Furthermore, the reaction force exerted on the lid 8 by the gasket 10 according to the embodiment in the state shown in FIG. 7 is only one third of the reaction force exerted on the lid 8 by the gasket 40 according to the comparative example in the state of FIG. 12.

When the distance D between the lid 8 and the flange 7 is narrowed, the increment of the reaction force exerted on the lid 8 by the gasket 10 according to the embodiment is much less than the increment of the reaction force exerted on the lid 8 by the gasket 40 according to the comparative example. According to the results of simulation, whereas the reaction force exerted on the lid 8 by the gasket 40 of the comparative example in the state shown in FIG. 13 is about 2.9 times the reaction force exerted on the lid 8 by the gasket 40 according to the comparative example in the state of FIG. 12, the reaction force exerted on the lid 8 by the gasket 10 according to the embodiment in the state shown in FIG. 6 is only about 1.7 times the reaction force exerted on the lid 8 by the gasket 10 according to the embodiment in the state shown in FIG. 5. Furthermore, the reaction force exerted on the lid 8 by the gasket 10 according to the embodiment in the state shown in FIG. 7 is only about 2.3 times the reaction force exerted on the lid 8 by the gasket 10 according to the embodiment in the state shown in FIG. 5.

Thus, by virtue of the gasket 10 according to the embodiment, since the reaction force exerted on members for which the gasket 10 is deployed is small, the strength needed for the member (lid 8 and flange 7 in the embodiment) can be reduced. For example, the thickness of the lid 8 and flange 7 can be reduced. In addition, the strength needed for the screws 9 (see FIG. 2) that fasten the lid 8 to the flange 7 can be reduced and/or the spacing between the screws 9 can be increased.

In the compressed portion 12 of the gasket 10 according to the embodiment, the width W₁ of the recess 30 formed on the lower surface 20 and the width W₂ of the recess 36 formed on the upper surface 22 are different from each other. The following is an explanation of the effect achieved by the difference.

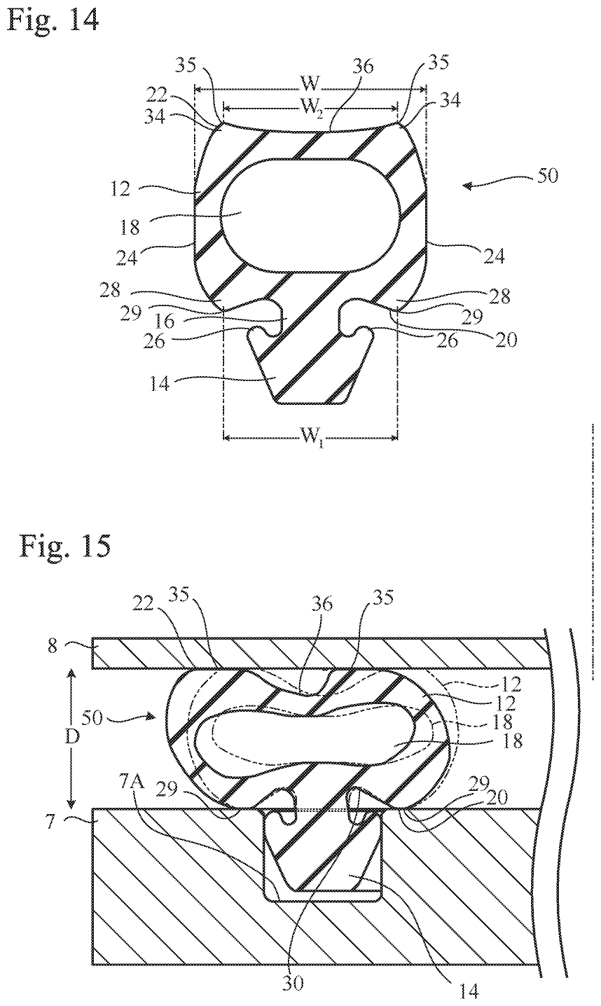

FIG. 14 shows a cross-section of another gasket 50 according to another comparative example in the uncompressed state. In the gasket 50 according to the comparative example, in the uncompressed state, the width W₁ of the recess 30 formed on the lower surface 20 is equal to the width W₂ of the recess 36 formed on the upper surface 22. Other features are the same as those in the gasket 10 according to the embodiment. FIG. 15 is a cross-sectional view of the gasket 50 compressed with a small force between the lid 8 and the flange 7 of the battery case 2, in which the distance D between the lid 8 and the flange 7 is the same as that in FIG. 5.

As can be clearly seen from FIG. 5 and FIG. 15 that both ends of the recess 30 (the apexes 29 of the ridges 28) and both ends of recess 36 (apexes 35 of the ridges 34) are points that initially receive compressive load in the deformation of the gasket 10 compressed by the lid 8 and flange 7.

In the gasket according to the comparative example, in which the width W₁ of the recess 30 and the width W₂ of the recess 36 are equal, the compressed portion 12 may deform behaving as if it were a parallel crank mechanism having pins connected at four apexes 29 and 35. In other words, as shown in FIG. 15, in the gasket 50 of the comparative example, the compressed portion 12 may tilt relative to the inserted portion 14 as it is compressed.

Furthermore, in the gasket 50 according to the comparative example, the behavior of the deformation of the compressed portion 12 is not reproducible. FIG. 15 shows that the compressed portion 12 tilts so that the upper surface 22 moves to the left relative to the lower surface 20, but conversely, the upper surface 22 may move to the right relative to the lower surface 20. Alternatively, instead of behaving similar to a parallel crank mechanism, two side walls of the compressed section 12 may evenly be deformed (maintaining the linear symmetry of the compressed section 12) as shown by the phantom lines in FIG. 15. The phantom lines in FIG. 15 show the contour of the compressed portion 12 and the cavity 18 when the compressed portion 12 deforms while maintaining the linear symmetry thereof.

In cases in which there is no repeatability of the deformation of the compressed section 12, the gasket 10 is less certain to achieve a desired (expected) sealing ability. In addition, if the compressed portion 12 deforms in a tilted manner in one cross-section and the compressed portion 12 deforms in a linearly symmetrical manner in another cross-section (i.e., if the gasket 1 is twisted), there is a risk that a gap will occur between the gasket 10 and the lid 8 and/or between the gasket 10 and the flange 7.

On the other hand, in the gasket 10 according to the embodiment, since the recess 30 overlaps the recess 36 and the widths W₁ and W₂ are different, as shown in FIGS. 5, 7, and 7, the compressed portion 12 does not tilt relative to the inserted portion 14 and is compressed with high repeatability of shape while maintaining the linear symmetry. Thus, the gasket 10 has a high degree of certainty of achieving a desired (expected) sealing ability.

### Second Embodiment

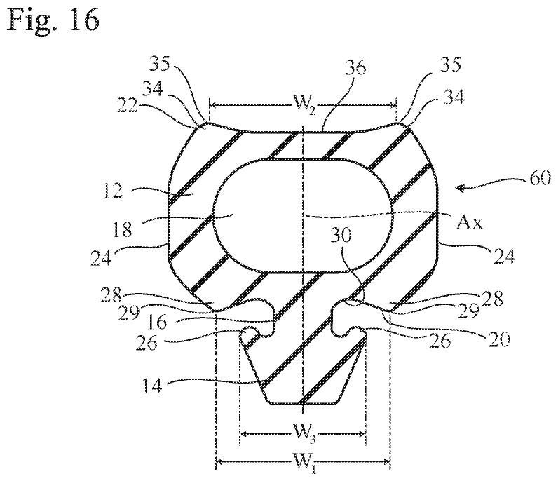

FIG. 16 shows a cross-section of a gasket 60 according to a second embodiment of the present invention in the uncompressed state.

In the gasket 60 in the uncompressed state, the width W₁ of the recess 30 formed on the lower surface 20 is less than the width W₂ of the recess 36 formed on the upper surface 22. Other features are the same as those in the gasket 10 according to the first embodiment.

Accordingly, in the gasket 60, since the compressed portion 12 has a hollow structure, even if the flatness of the flange 7 and the lid 8 is low, the compressed portion 12 can maintain the sealing ability thereof for a long time. Accordingly, in the gasket 60, since the compressed portion 12 has a hollow structure, even if the flatness of the flange 7 and the lid 8 is low, the compressed portion 12 can maintain the sealing ability for a long period of time, and the reaction force exerted on the flange 7 and the lid 8 is small. In addition, since the recess 30 overlaps the recess 36 and the width W₁ of the recess 30 is different from the width W₂ of the recess 36, the compressed portion 12 does not tilt relative to the inserted portion 14 and is compressed with high repeatability of shape, e.g., while maintaining the linear symmetry. Thus, the gasket 60 has a high degree of certainty of achieving a desired sealing ability.

### Other Modifications

The present invention has been shown and described with reference to preferred embodiments thereof. However, it will be understood by those skilled in the art that various changes in form and detail may be made without departing from the scope of the invention as defined by the claims. Such variations, alterations, and modifications are intended to be encompassed in the scope of the present invention.

For example, in the above-described embodiments, the gasket is used in a battery case of an electric automotive vehicle. However, the gasket according to the present invention may also be used for other applications, such as sealing between a lid and a container of an inverter case of an electric automotive vehicle, sealing between a lid and a container of a storage case for a fuel cell stack of a fuel cell automotive vehicle, sealing between a door and a wall of an airtight room, sealing between a door and a wall of a refrigerator, etc.

In the above-described embodiments, the gasket has a linearly symmetrical shape about the central axis Ax, but it does not need to be perfectly linearly symmetrical.

Aspects of the present invention are also set out in the following numbered clauses:

Clause 1. A gasket including:
a compressed portion formed from an elastomer material and adapted to be compressed between a first member and a second member, the compressed portion having a width;
an inserted portion formed from the elastomer material and adapted to be inserted into a groove formed in the first member, the inserted portion having a maximum width; and
a neck portion formed from the elastomer material having a width that is less than the width of the compressed portion and the maximum width of the inserted portion, the neck portion being integrally coupled with the compressed portion and the inserted portion and connecting the compressed portion and the inserted portion,
the compressed portion including a hollow structure having a cavity, and including a substantially rectangular contour including a first outer surface adapted to be brought into contact with the first member and a second outer surface that is opposite to the first outer surface and adapted to be brought into contact with the second member,
the first outer surface including a first recess having a first width, the first recess having a center to which the neck portion is coupled,
the second outer surface including a second recess having a second width,
the first recess overlapping the second recess, the first width being different from the second width.

Clause 2. The gasket according to clause 1, wherein the compressed portion, the inserted portion, and the neck portion have cross-sections that are linearly symmetrical about a central axis.

According to this clause, the gasket can be easily manufactured, for example, using a mold having a linearly symmetrical cavity.

Clause 3. The gasket according to clause 1 or 2, wherein each of the compressed portion, the inserted portion, and the neck portion is formed in an endless loop.

According to this clause, the gasket is capable of separating the inner space of the loop from the outer space.

Clause 4. The gasket according to any one of clauses 1 to 3, wherein the first width is greater than the second width.

Clause 5. The gasket according to any one of clauses 1 to 3, wherein the first width is less than the second width.

Clause 6. The gasket according to any one of clauses 1 to 5, wherein the maximum width of the inserted portion is greater than a width of the groove.

According to this clause, once the inserted portion is inserted into the groove, the inserted portion adheres to both walls of the groove.

Clause 7. The gasket according to any one of clauses 1 to 6, wherein the inserted portion has a tapered shape having a width that decreases as the distance from the compressed portion increases.

According to this clause, the inserted portion can be easily inserted into the groove.

Clause 8. The gasket according to any one of clauses 1 to 7, wherein the inserted portion has two projections disposed on both sides of the neck portion and extending toward the compressed portion.

According to this clause, it is possible to secure a large interference of the inserted portion.

1. A gasket comprising:
a compressed portion formed from an elastomer material and adapted to be compressed between a first member and a second member, the compressed portion having a width;
an inserted portion formed from the elastomer material and adapted to be inserted into a groove formed in the first member, the inserted portion having a maximum width; and
a neck portion formed from the elastomer material having a width that is less than the width of the compressed portion and the maximum width of the inserted portion, the neck portion being integrally coupled with the compressed portion and the inserted portion and connecting the compressed portion and the inserted portion,
the compressed portion comprising a hollow structure having a cavity, and comprising a substantially rectangular contour comprising a first outer surface adapted to be brought into contact with the first member and a second outer surface that is opposite to the first outer surface and adapted to be brought into contact with the second member,
the first outer surface comprising a first recess having a first width, the first recess having a center to which the neck portion is coupled,
the second outer surface comprising a second recess having a second width,
the first recess overlapping the second recess, the first width being different from the second width.

2. The gasket according to claim 1, wherein the compressed portion, the inserted portion, and the neck portion have cross-sections that are linearly symmetrical about a central axis.

3. The gasket according to claim 1, wherein each of the compressed portion, the inserted portion, and the neck portion is formed in an endless loop.

4. The gasket according to claim 1, wherein the first width is greater than the second width.

5. The gasket according to claim 1, wherein the first width is less than the second width.

6. The gasket according to claim 1, wherein the maximum width of the inserted portion is greater than a width of the groove.

7. The gasket according to claim 1, wherein the inserted portion has a tapered shape having a width that decreases as the distance from the compressed portion increases.

8. The gasket according to claim 1, wherein the inserted portion has two projections disposed on both sides of the neck portion and extending toward the compressed portion.

9. The gasket according to claim 1, wherein the compressed portion comprises at least one air vent hole.
